(19) United States
(12) Patent Application Publication
(10) Pub. No.: US 2016/0264436 A1
(43) Pub. Date: Sep. 15, 2016

(54) FLUID TREATMENT APPARATUS

(71) Applicants: Kenichi HAYAKAWA, Kanagawa (JP); Satoshi SHINOHARA, Ibaraki (JP); Toshiyuki MUTOH, Kanagawa (JP); Shogo SUZUKI, Kanagawa (JP); Yuu ZAMA, Kanagawa (JP); Kimio AOKI, Kanagawa (JP)

(72) Inventors: Kenichi HAYAKAWA, Kanagawa (JP); Satoshi SHINOHARA, Ibaraki (JP); Toshiyuki MUTOH, Kanagawa (JP); Shogo SUZUKI, Kanagawa (JP); Yuu ZAMA, Kanagawa (JP); Kimio AOKI, Kanagawa (JP)

(21) Appl. No.: 15/067,738

(22) Filed: Mar. 11, 2016

(30) Foreign Application Priority Data
Mar. 12, 2015 (JP) 2015-049713
Dec. 4, 2015 (JP) 2015-237981

(51) Int. Cl. C02F 1/72

(52) U.S. Cl. CPC C02F 1/72; C02F 2101/30

(57) ABSTRACT

A fluid treatment apparatus includes a reactor that decomposes an organic matter contained in a mixed fluid of a fluid to be treated and an oxidizing agent, an oxidizing agent injector that includes an injection port to inject the oxidizing agent into the reactor, a fluid discharger that is disposed to surround the oxidizing agent injector and includes an outlet to discharge the fluid in the reactor, and a pressurizer that pressurizes the oxidizing agent. The fluid discharger has a fluid passage a diameter of which is larger than a maximum particle diameter of a solid material contained in the fluid and a shape of which does not create a pressure difference in the fluid passage, the outlet of the fluid discharger being provided to discharge the fluid toward the oxidizing agent injector. The apparatus atomizes the fluid by pressure energy of the injected oxidizing agent.

### CROSS-REFERENCE TO RELATED APPLICATION

The present application is based on and claims priority to Japanese patent application No. 2015-049713 filed on Mar. 12, 2015 and Japanese patent application No. 2015-237981 filed on Dec. 4, 2015, the disclosures of which are hereby incorporated by reference herein in its entirety.

### BACKGROUND

1. Technical Field

The disclosure relates to a fluid treatment apparatus.

2. Description of Related Art

Conventionally, a method for decomposing wastewater (fluid to be treated) containing organic matters so as to detoxify the wastewater, for instance, an oxidation treatment in highly pressurized water at high temperature such as supercritical water oxidation has been known. Under such an oxidation treatment, the fluid to be treated is fed to a reactor together with an oxidizing agent. However, if the fluid to be treated is fed to the reactor without any care, a droplet of the fluid may be too large to evaporate before reaching the bottom of the reactor, resulting in an insufficient treatment.

Patent Literature 1 (JPH10-137774 A) discloses a double tube structure including an inner tube that discharges the fluid to be treated and an outer tube that injects oxidizing agent and supercritical water. In the double tube structure, an injection speed of the oxidizing agent and supercritical water is set faster than a discharge speed of the fluid to be treated so as to atomize the fluid to be treated. A configuration of its nozzle is designed based on the shearing effect achieved by the difference between the injection speed and the discharge speed. In order to improve the shearing effect, the double tube structure of Patent Literature 1 is designed such that a fluid passage diameter of the inner tube, which is used for discharging the fluid to be treated, is small. Further, by atomizing the fluid to be treated, the surface area of the fluid is increased, which allows the fluid to easily evaporate. With this, it improves the reaction efficiency. Further, Patent Literature 2 (JPH5-208148 A) discloses a multi-head injection nozzle including two nozzles that face each other. With this, the fluid injected from each nozzle crashes such that ultra-fining particles are obtained. Here, fluid passages of the nozzles are formed in an outer peripheral part surrounding the air passages for injecting air.

### SUMMARY

The wastewater treated by this sort of fluid treatment apparatus often contains solid materials such as organic matters and inorganic matters. As disclosed in Patent Literature 1, it becomes easy to atomize the fluid to be treated by making the fluid passage diameter of the inner tube small. However, this kind of nozzle structure is liable to cause clogging of solid materials contained in the wastewater. Thus, the kind of fluid to be treated by the apparatus of Patent Literature 1 may be limited. On the other hand, if the fluid passage diameter of the inner tube is made large to avoid the occurrence of clogging of solid materials, it makes difficult for the oxidizing agent and the like, which is injected from outside, to reach the center of liquid column of the fluid, which is discharged from the inner tube. As a result, the atomizing effect is unavoidably reduced.

For a nozzle structure of this kind of fluid treatment apparatus, it is easier to atomize the fluid to be treated if a difference between the pressure inside the reactor and the supply pressure of the fluid discharged from the nozzle is larger. Alternatively, it is easy to atomize the fluid if the discharge port of the fluid is made narrow like a slit to form a thin liquid film. In such a case, the width of the discharge port for the fluid has to be small. However, as described above, when the fluid contains solid materials such as organic matters and inorganic matters, this structure should not be used to avoid an occurrence of clogging. Alternatively, it is easy to atomize the fluid if the air injection speed is increased. However, when the air injection speed is too high, the pressure difference with respect to the pressure inside the reactor becomes too high, which may cause a malfunction such as breakage of the apparatus. Alternatively, it is easy to atomize the fluid if the flow rate of the air is increased. However, the flow rate of the air should be limited to suppress the occurrence of toxic substances such as nitrogen oxide.

A main object of the present invention is, therefore, to provide a fluid treatment apparatus that can prevent the occurrence of clogging of solid matters contained in the fluid to be treated while improving the reaction efficiency by atomizing the fluid.

To achieve the above object, an aspect of the present invention provides a fluid treatment apparatus includes a reactor that decomposes an organic matter contained in a mixed fluid of a fluid to be treated and an oxidizing agent so as to treat the fluid, an oxidizing agent injector that includes an injection port to inject the oxidizing agent into the reactor, a fluid discharger that is disposed to surround the oxidizing agent injector and includes an outlet to discharge the fluid in the reactor, and a pressurizer that pressurizes the oxidizing agent. The fluid discharger has a fluid passage a diameter of which is larger than a maximum particle diameter of a solid material contained in the fluid and a shape of which does not create a pressure difference in the fluid passage, the outlet of the fluid discharger being provided to discharge the fluid toward the oxidizing agent injector. The apparatus atomizes the fluid by pressure energy of the injected oxidizing agent.

### BRIEF DESCRIPTION OF DRAWINGS

FIG. 1 is a schematic view illustrating a fluid treatment apparatus according to a first embodiment of this disclosure;

FIG. 2 is a section view schematically illustrating a nozzle part;

FIG. 3 is a section view taken along a C-C line of FIG. 2;

FIG. 4 is an enlarged view illustrating a structure around an injection port of the nozzle;

FIG. 5 is a longitudinal section view around an injection port of a nozzle according to a second embodiment of this disclosure;

FIG. 6 is a photo image of a result achieved by atomization in an Example 1;

FIG. 7 is a photo image of a result achieved by atomization in an Example 2; and

FIG. 8 is a view illustrating a configuration of an experiment to confirm an effect of the nozzle according to the second embodiment of this disclosure;

FIG. 9 is a characteristic chart showing output values and preheating temperature of a first preheater with respect to concentrations of a methanol aqueous solution;

FIG. 10 is a characteristic chart showing temperature inside a reactor with and without the nozzle;

FIG. 11 is a characteristic chart showing viscosity and shearing speed of fluid to be treated; and

FIG. 12 is a distribution map showing particle size distribution of a solid material contained in the fluid.

### DETAILED DESCRIPTION

### Embodiment 1

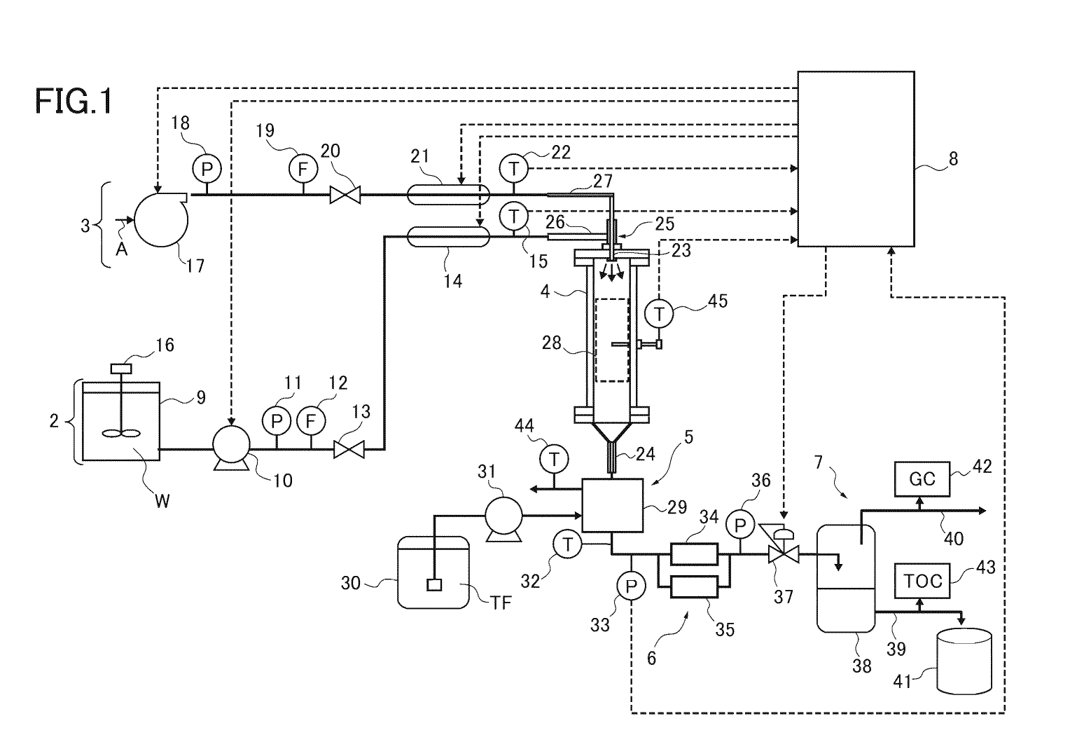

Hereinafter, embodiments of this disclosure will be described with reference to the drawings. FIGS. 1 to 4 show a first embodiment, and an overall structure of a fluid treatment apparatus according to the first embodiment will be described with reference to FIG. 1.

A fluid supplier 2 includes a raw water tank 9. The raw water tank 9 stores fluid to be treated W (hereinafter, may also simply be called “fluid W”) containing organic matters. Here, the concentration of the organic matter contained in the fluid is adjusted before storing the fluid W in the raw water tank 9. The fluid W is pumped to a reactor 4 by a raw water supply pump 10. The pressure and flow rate of the fluid W supplied to the reactor 4 are respectively detected by a pressure sensor 11 and a raw water flowmeter 12. The flow rate of the fluid W is adjustable by the raw water supply pump 10. A raw water input valve 13 is provided downstream of the raw water flowmeter 12.

The fluid W passed through the raw water input valve 13 is preheated by a first preheater 14 if needed. A first outlet temperature sensor 15 is provided downstream of the first preheater 14. The raw water tank 9 includes a stirring machine 16 to stir the fluid W so as to uniform components of the fluid W.

An oxidizing agent supplier 3 includes an oxidizing agent pump (pressurizer) 17 to pressurize the oxidizing agent. Here, the oxidizing agent pump 17 pressurizes and compresses the oxidizing agent by a compressor. The oxidizing agent pump 17 takes in air A (i.e., oxidizing agent) and supplies the air to the reactor 4 after pressurizing the air nearly equal to treatment pressure. The pressure and flow rate of the air supplied to the reactor 4 are respectively detected by an oxidizing agent pressure sensor 18 and an oxidizing agent flowmeter 19. An oxidizing agent flow rate regulation valve 20 is provided downstream of the oxidizing agent flowmeter 19.

The air passed through the regulation valve 20 is preheated by a second preheater 21 if needed. A second outlet temperature sensor 22 is provided downstream of the second preheater 21. The fluid W passed through the first preheater 14 and the air passed through the second preheater 21 are independently fed to and joined in the reactor 4. Here, the supply pressure of the fluid W is adjusted to a reaction pressure. The supplying pressure of the air is set higher than the pressure in the reactor 4 since an air feeding port of the reactor 4 generates a pressure loss.

The amount of the air to be supplied by the oxidizing agent pump 17 is determined based on the required oxygen amount to completely oxidize the organic matters contained in the fluid to be treated W. Here, the required oxygen amount is calculated stoichiometrically. Specifically, the required oxygen amount is calculated based on a concentration of the organic mattes, a concentration of nitrogen, a concentration of phosphorus, and the like (i.e., based on a total organic carbon (TOC), a total inorganic nitrogen (TN), a total phosphorus (TP), and the like contained in the fluid W). The amount of the oxygen to be supplied is determined so as to be one time to three times greater than the required amount to fully oxidize the organic matters. Note that the oxidizing agent should not be limited to the air. For instance, it may be one of air, oxygen, and ozone, or a combination thereof.

The pressure applied to the mixed fluid inside the reactor 4 is set to be, for example, within a range of 0.5 to 30 MPa (preferably, 5 to 15 MPa), and the pressure inside the reactor 4 is controlled by an outlet valve 37. When the pressure inside the reactor 4 becomes higher than a threshold value, the outlet valve 37 is automatically opened to drain the mixed fluid from the reactor 4 to keep the pressure at the threshold value. The temperature of the mixed fluid inside the reactor 4 is set to be, for example, between 100 to 700° C. (preferably, between 200 to 550° C.). Here, the temperature of the mixed fluid inside the reactor 4 is increased by the first preheater 14 and the second preheater 21 and/or by heat generated by oxidation decomposition of the organic matters.

When the fluid to be treated W contains the organic matters in high concentration, the temperature of the mixed fluid may be increased to a desired temperature by only the heat generated by the oxidation decomposition. In such a case, the apparatus operates the first and second preheaters 14 and 21 only when starting-up the apparatus, and stops the first and second preheaters 14 and 21 once the oxidation decomposition is started. With this, it reduces power consumption. Note that the heating temperature is adjusted by controlling the output of the first and second preheaters 14 and 21.

The reactor 4 has a cylindrical shape having a feeding port 23 at one end and a drain port 24 at the other end. The reactor 4 mixes the fluid to be treated W and the oxidizing agent under a high temperature and high pressure condition so as to decompose the organic matters contained in the fluid W (i.e., so as to treat the fluid W). The reactor 4 includes a space to secure the reaction time while maintaining the high temperature and high pressure condition. The feeding port 23 is equipped with a nozzle 25 to atomize the fluid to be treated W. The nozzle 25 is connected to both a first inflow pipe 26 for the fluid W and a second inflow pipe 27 for the oxidizing agent.

The mixed fluid moves from the above to the bottom along the longitudinal direction in the reactor 4. The mixed fluid reached the bottom of the reactor 4 is in a state in which the organic matters have almost completely been oxidation-decomposed. Therefore, the mixed fluid reached the bottom of the reactor 4 is discharged from the drain port 24 as treatment-finished fluid. The reactor 4 is formed in a double cylindrical structure including an outer cylinder and an inner cylinder tightly accommodated in the outer cylinder. Depending on types of the fluid to be treated W, the inner wall of the inner cylinder may be exposed under strong acidic condition since the fluid W may generate a hydrochloric acid derived from a chloro group of an organic chloride or a sulfuric acid derived from a sulfonyl group of, for example, amino acid. Therefore, the inner cylinder is made of a material such as titanium having high corrosion resistance.

Note that the inner cylinder may be made of tantalum (Ta), gold (Au), platinum (Pt), iridium (Ir), rhodium (Rh), or palladium (Pd). Alternatively, the inner cylinder may be made of an alloy containing at least one of titanium (Ti), tantalum (Ta), gold (Au), platinum (Pt), iridium (Ir), rhodium (Rh), and palladium (Pd). The outer cylinder is made of a metal material having high strength such as stainless (SUS304, SUS316) and inconel 625. When a difference of the thermal expansion coefficients of the inner cylinder and outer cylinder is relatively large, the reactor 4 may be configured to be a pressure balance type in which a space is formed between the outer cylinder and the inner cylinder. The space is filled with water (pressure equalizing water) so as to equalize the pressure of the space and the pressure inside the inner cylinder.

A catalyst member 28 is provided in the reactor 4. It is effective to use a catalyst to completely decompose organic matters under overheating steam atmosphere. By using a catalyst, it even oxidation-decomposes remaining organic matters or remaining ammonia nitrogen, resulting in achieving a complete treatment.

At least a surface of a catalyst layer of the catalyst member 28 is formed of a catalyst substance that accelerates the oxidation decomposition of the organic matters. For instance, the catalyst substance is made of ruthenium (Ru), palladium (Pd), rhodium (Rh), gold (Au), iridium (Ir), osmium (Os), iron (Fe), copper (Cu), zinc (Zn), nickel (Ni), cobalt (Co), cerium (Ce), titanium (Ti), or manganese (Mn). Alternatively, the catalyst substance may be made of an alloy containing at least one of these substances.

A base material of the catalyst member 28 may be made of an alloy containing at least one of iron (Fe), nickel (Ni), chromium (Cr), and molybdenum (Mo). Alternatively, the base material may be made of an alloy containing at least one of titanium (Ti), gold (Au), platinum (Pt), rhodium (Rh), palladium (Pd), zirconium (Zr), and vanadium (V). Alternatively, the base material may be made of ceramic or quartz glass. That is, the substance of the base material is selected from the above substances in accordance with, for example, cost, workability, easiness of coating, mechanical strength, and heat resistance and corrosion resistance under the reaction condition.

The treatment-finished fluid discharged from the reactor 4 is sent to a heat exchanger 29 of a heat exchange section 5. The heat exchange section 5 includes a heat catalyst tank 30 in which heat exchange fluid TF is stored. The heat exchange fluid TF is supplied to the heat exchanger 29 by a heat exchange pump 31. The heat exchange fluid TF may be high pressure water. In such a case, the high pressure water would be converted into high pressure steam by the heat exchanger 29 and utilized to produce stream inside a building. That is, it is possible to take out thermal energy from the treatment-finished fluid by using the heat exchanger so as to effectively utilize the taken out energy.

A solid material separation section 6 includes a first separation system 34 and a second separation system 35. The first separation system 34 includes a first branch valve, a first separation filter, a first drain valve, and the like. The second separation system 35 includes a second branch valve, a second separation filter, a second drain valve, and the like. The oxide (solid material) deposited in the reactor 4 is collected by the first separation filter or the second separation filter.

A gas-liquid separation section 7 includes an outlet valve 37, a gas-liquid separator 38, and the like. The treatment-finished fluid passed through the solid material separation section 6 is separated into treated water 39 (i.e., treated liquid) and gas 40 by the gas-liquid separator 38. The treated water 39 is stored in a treated water tank 41. The gas separated by the gas-liquid separator 38 is sent to a gas chromatograph (GC) to detect the compositions thereof. When the gas chromatograph detects an undecomposed substance, a controller 8 receives a signal output from the gas chromatograph and raises an alarm.

The treated water 39 separated by the gas-liquid separator 38 is sent to a TOC analyzer 43 to detect a concentration of the total organic carbon (i.e., a TOC concentration). When the TOC analyzer 43 detects that the TOC concentration exceeds a threshold value, the controller 8 receives a signal output from the TOC analyzer 43 and raises an alarm.

If the fluid W is normally treated, the treated water does not contain a floating substance or an organic matter. That is, even organic matters having a low molecule that cannot be treated by a biological treatment using activated sludge are almost completely oxidation-decomposed. Therefore, it is possible to utilize the treated water as industrial water without an additional process. Further, it is possible to utilize the treated water for cleaning liquid after a filtration process using an ultrafiltration membrane. Note that the gas separated by the gas-liquid separator 38 mainly includes carbon dioxide, nitrogen, and oxygen.

The controller 8 is a microcomputer including an I/O interface, a CPU, a ROM, a RAM, and the like. The controller 8 receives information of the flow rate, pressure, and temperature detected by each instrument and information of each device such as the pumps. The controller 8 controls the pumps, preheaters, regulation valve, open/close valve, and the like. The controller 8 is connected to a touch panel as an input device and a display. That is, the temperature, pressure, flow rate, and information regarding the alarm are displayed on the touch panel, and the user can input and change the setting values through the touch panel.

Upon an occurrence of an abnormality, an interlock control is executed. That is, the pumps operation and power supply to the heaters are shut off and/or the inlet valve is closed. Here, examples of the abnormality are, a device failure, clogging of a fluid passage, and a leak from a fluid passage. The controller 8 determines an occurrence of an abnormality based on abnormal pressure and/or abnormal temperature, and the user can monitor the condition with the touch panel. In FIG. 1, reference sign 44 denotes a steam temperature sensor that detects steam temperature discharged from the heat exchanger 29 to a heat energy utilizing facility, and reference sign 45 denotes a reactor temperature sensor to detect the reaction temperature inside the reactor 4.

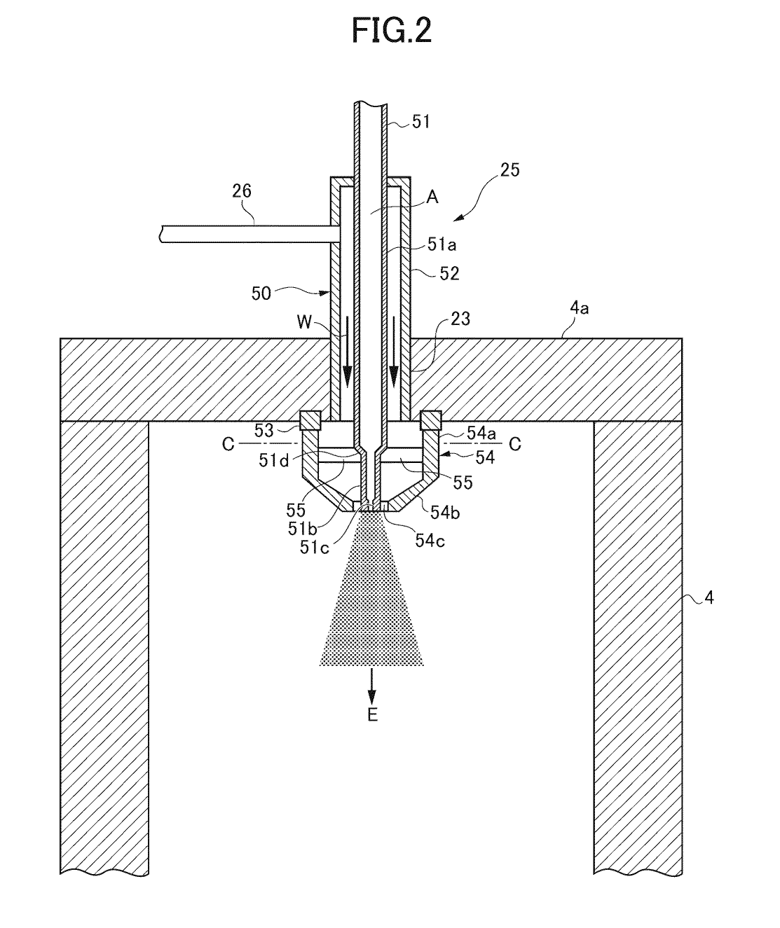

A configuration of the nozzle 25 will be explained with reference to FIG. 2. The nozzle 25 includes a fluid discharger 50 and an oxidizing agent injector 51. Here, the fluid discharger 50 is connected to the inflow pipe 26 for the fluid to be treated W, and the oxidizing agent injector 51 is connected to the inflow pipe 27 for the oxidizing agent so as to inject compressed high-pressure air. The fluid discharger 50 is provided along the whole outer circumferential surface of the oxidizing agent injector 51. That is, the nozzle 25 is formed in the double tube structure. The fluid discharger 50 is configured with a fixed cylinder 52 and a positioning member 54. The fixed cylinder 52 is inserted to the feeding port 23 of the reactor 4 to be fixed to an upper cover 4a of the reactor 4. The positioning member 54 is detachably provided to the inner surface side of the upper cover 4a with a connector 53. The inflow pipe 26 for the fluid to be treated W is connected to the fixed cylinder 52 from a direction orthogonal to the longitudinal direction (i.e., vertical direction) of the reactor 4. The oxidizing agent injector 51 is inserted through the fixed cylinder 52 from the upper surface of the fixed cylinder 52.

The positioning member 54 includes a cylindrical part 54a and a conical part 54b and forms a circular outlet 54c at the center portion at the bottom surface of the conical part 54b to discharge the fluid to be treated W. The diameter of the cylindrical part 54a is constant, while the diameter of the conical part 54b is gradually decreased as it goes to the lower side. Note that the oxidizing agent injector 51 is disposed at the center of the outlet 54c. Therefore, although the outlet 54c has a circular shape, the substantial shape of the outlet 54c is an annular or a ring shape.

The fluid discharger 50 has a fluid passage the shape of which does not create a pressure difference (pressure loss) from the fixed cylinder 52 to the outlet 54c. To be specific, although the inner diameter of the positioning member 54 is wider than that of the fixed cylinder 52 and the diameter of the outlet 54c is smaller than the inner diameter of the fixed cylinder 52 (i.e., although the inner diameter of the fluid discharger 50 changes), the dimensional relation of each member does not create a pressure difference unlike an orifice.

The oxidizing agent injector 51 is supported by four spacers 55 provided inside the cylindrical part 54a. The spacers 55 position the oxidizing agent injector 51 such that an injection port 51c is provided at the center of the outlet 54c and the heads of the outlet 54c and of the injection port 51c coincide with each other in the injection direction indicated by an arrow E. That is, the oxidizing agent injector 51 is positioned radially and vertically by the spacers 55.

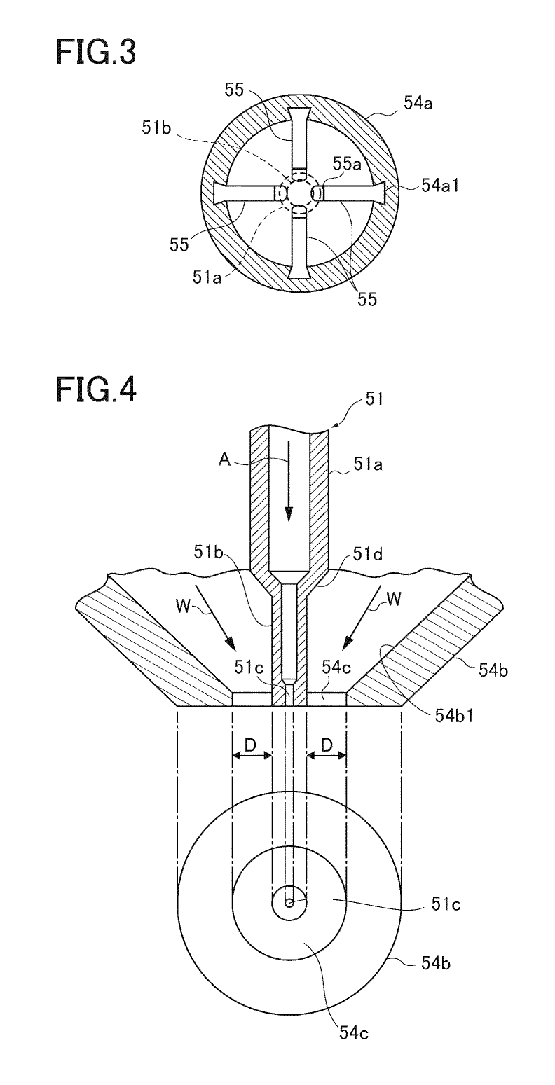

As illustrated in FIG. 3, the spacers 55 are each fixed on the cylindrical part 54a in a cantilever state by inserting their end parts in key grooves 54al formed in the cylindrical part 54a. Each of the open ends of the spacers 55 has an inclined face 55a. As illustrated in FIG. 2, the oxidizing agent injector 51 includes the introduction portion 51a having a wider cross-section area and the injection portion 51b having a smaller cross-section area. The bottom end (i.e., head) of the injection portion 51b forms in the injection port 51c. The boundary of the introduction portion 51a and the injection portion 51b has a slope 51d, and the slope 51d abuts on the inclined faces of the spacers 55 to position the oxidizing agent injector 51. In this embodiment, the number of the spacers 55 are four, but the number may be three. By supporting and positioning the oxidizing agent injector 51 with the narrow spacers 55, it becomes possible to easily and accurately position the injection port 51c for the oxidizing agent and the outlet 54c for the fluid to be treated W without disturbing the flow of the fluid W in the fluid discharger 50, where the positions of the injection port 51c and the outlet 54c have a significant impact on the atomization of the fluid to be treated W.

When the connector 53 is configured such that the position of the connector 53 in the vertical direction is adjustable according to the rotation amount of the connector 53, it can correct a positional displacement caused by aged deterioration such as wearing between the injection port 51c and outlet 54c.

As illustrated in FIG. 4, the head of the injection portion 51b of the oxidizing agent injector 51 is further narrowed to form the injection port 51c. Similar to the outside, the inside of the conical part 54b of the positioning member 54 also has an inclined face 54b1. With this, the fluid to be treated W is guided to the outlet 54c.

After being discharged from the outlet 54c, the fluid W is atomized by the compressed high-pressure air injected from the injection port 51c as illustrated in FIG. 2. Since the air is compressive fluid, the air stores pressure energy when being compressed. When air is compressed to be high density, the number of air molecules per unit time is increased. Since the inside of the reactor 4 is also highly pressurized, the compressed air is injected while keeping the high pressure energy.

The density inside the reactor 4 and the density of the compressed air are nearly equal to each other. That is, a difference (pressure difference) between the pressure inside the reactor 4 and the supplied pressure of the compressed air is relatively small. With this, it becomes easy to atomize the fluid to be treated W even without increasing the injection speed. In other words, the nozzle 25 according to this embodiment is configured to atomize the fluid W discharged from the fluid discharger 50, which does not have an orifice to create a pressure difference, by only the pressure energy of the compressed air.

When the fluid W contains solid materials such as organic matters and inorganic matters, the nozzle 25 may be clogged if the cross-section area of the outlet 54c is small. In order to prevent the clogging, an aperture width D of the outlet 54c is designed to be larger than the maximum diameter (i.e., maximum particle diameter) of the solid material contained in the fluid W, as illustrated in FIG. 4.

The cross-section area of the outlet 54c is preferably designed to be large such that it suppresses a pressure loss of the fluid W in the fluid discharger 50 as much as possible. Besides, it should be designed such that the fluid W is not unevenly discharged from the outlet 54c but uniformly discharged from the outlet 54c. Note that if the cross-section area of the outlet 54c with respect to the flow rate of the fluid W is larger than a threshold, the fluid W may shrink to be smaller than the cross-section area of the outlet 54c and may be discharged from the outlet 54c unevenly.

Specifically, the cross-section area of the outlet 54c is preferably determined such that the discharge speed of the fluid W becomes less than 1.0 m/s. When the flow rate of the fluid W is 10 kg/h, the cross-section of the outlet 54c is preferably set to be in a range of 2.8 to 10.0×10 m² and the aperture width D of the outlet 54c is preferably set to be in a range of 0.5 mm to 2.0 mm.

In an external mixing type binary fluid nozzle that mixes two fluids at outside the nozzle and atomizes the mixed fluids, a width of the fluid passage on a tank side is nearly equal to that on the outlet side. Or, the nozzle has an orifice in the fluid passage on the tank side. However, when the fluid contains solid materials, it may cause clogging of the fluid passage if the width of the fluid passage is small (or if the fluid passage has an orifice). Therefore, it is preferable to make the fluid passage of the fluid W equal to or wider than the aperture width D of the outlet 54c in order to prevent the clogging. As illustrated in FIG. 2, in this embodiment, both the fluid passages of the fixed cylinder 52 and positioning member 54 of the fluid discharger 50 are wider than the aperture width D.

Although the pressure of the oxidizing agent must be higher than the pressure inside the reactor 4, it is preferable to supply the oxidizing agent in a state where the pressure difference with respect to the pressure inside the reactor 4 is as small as possible. This is because having a large pressure difference may damage the apparatus. Here, the pressure inside the reactor 4 of the fluid treatment apparatus according to this embodiment is kept high, and therefore, a startup cost and a running cost of the apparatus become high in order to supply high pressure air (i.e., oxidizing agent).

Therefore, in this embodiment, the supply pressure of the compressed air is determined such that the pressure difference between the supply pressure of the oxidizing agent and the pressure inside the reactor 4 is smaller than 2 MPa (predetermined value). To suppress the pressure difference, it is preferable to have a wider fluid passage except for the part of the injection port 51c of the oxidizing agent injector 51. As illustrated in FIG. 4, the inner diameter of the oxidizing agent injector 51 is gradually narrowed as it goes toward the injection port 51c. That is, the relationship of the inner diameters of the oxidizing agent injector 51 is expressed as: introduction portion 51a>injection portion 51b>injection port 51c.

In the normal binary fluid nozzle, as the gas flow rate is set greater, spraying the fluid becomes easier. However, from a view point of an effective process and a view point of suppressing an occurrence of toxic substances such as nitrogen oxides, the amount of oxygen in the reactor 4 should not be excessive. In this embodiment, the amount of oxygen to be supplied is set to be 1.0 to 3.0 times greater than the required oxygen amount to completely oxidize the organic matters. Preferably, it is set to be 1.2 to 2.0 times greater than the required oxygen amount.

Additionally, from a view point of the running cost, it is preferable that the oxidizing agent injected from the oxidizing agent injector 51 does not contain supercritical water or overheating steam. Note when compressed air is selected as the oxidizing agent, the compressed air is generated by compressing atmospheric air using, for example, a compressor. In such a case, water vapor contained in the atmospheric air may become supercritical water or overheating steam during the compression process such that the oxidizing agent may contain the supercritical water or overheating steam unavoidably. However, such a case is an exception. Note that in this embodiment, the injection port 51c has a circular shape and the fluid passage is constant. However, they should not be limited thereto.

The inventors of this disclosure carried out experiments under a condition where the aperture width of the outlet 54c is kept wide to prevent from clogging of solid materials and the pressure difference is kept nearly zero. As a result, the inventors discovered a condition capable of atomizing the fluid to be treated W even if the injection speed of the oxidizing agent is slow and the oxygen amount is small. Specifically, the inventors confirmed that it efficiently atomizes the fluid W using the externally mixing type binary fluid nozzle 25 and the fluid treatment apparatus exhibits a sufficient function to oxidation-decompose the fluid W under the following conditions.

(1) The supply pressure of the oxidizing agent is equal to or higher than the atmospheric pressure, preferably, higher than 3 MPa. With this, the density of the oxidizing agent increases and the injection energy of the oxidizing agent utilized for the atomization of the fluid increases. Besides, the pressure difference decreases. (2) The cross-section area of the injection port 51c is set such that the injection speed of the oxidizing agent becomes less than a threshold value (200 m/s). It is preferable that the pressure difference is smaller than 2 MP. (3) When Q1 represents the flow rate of the oxidizing agent and Q2 represents the flow rate of the fluid to be treated W, the equation Q1/Q2 is set to be 0.3 or more to less than 6.0. (4) When S1 represents the cross-section area of the fluid passage of the injection port 51c and S2 represents the cross-section area of the outlet 54c, the ratio of S1:S2 is set to be in a range between 1:1 and 1:40.

Through the experiments under the above condition, the inventors also confirmed that the fluid to be treated W was atomized such that the maximum diameter of the droplet of the fluid W became less than 250 μm. The results show that the sufficient particle diameter was achieved by increasing the injection energy of the oxidizing agent. That is, the injection energy is increased by increasing the supply pressure of the oxidizing agent so as to achieve the high density. For instance, when the atmospheric air is utilized for the oxidizing agent, the injection force under high pressure is greater than the injection force under the atmospheric pressure in accordance with the difference of the air densities. When the pressure is 4 MPa, the air density is fifty times higher than that under the atmospheric pressure.

In this embodiment, the nozzle 25 is an internal-air type nozzle in which the injection port 51c for the oxidizing agent is surrounded by the outlet 54c for the fluid to be treated W. By having such a structure, it can suppress changes of the shape and/or the cross-section area of the injection port 51c when the flow rate of the fluid W is low. Further, it can suppress the deterioration of the spraying performance. Here, the minimum flow rate of the oxidizing agent required for the treatment is low when the flow rate of the fluid W is low. Thus, the cross-section area of the injection port 51c for the oxidizing agent should be decreased. When the nozzle 25 is an external-air type nozzle in which the outlet for the fluid is surrounded by the injection port, the injection port for the oxidizing agent should have a thin slit shape in order to secure the injection speed of the oxidizing agent.

However, for the fluid treatment apparatus using highly pressurized water at high temperature, the spraying performance may be deteriorated because it is difficult to maintain the thin and annular shape slit and shape under such a condition. Specifically, the nozzle is heated by the heat of the high temperature reactor 4, the radial heat, and the heat from the preheated oxidizing agent, and is cooled by the fluid to be treated W, which causes thermal expansion and thermal shrinkage of the metal parts of the nozzle. As a result, width of the slit having the narrow and ring shape changes. If the shape and/or the cross-section of the injection port changes, the injection speed of the oxidizing agent also changes, thereby influencing the spraying performance.

On the other hand, in the internal-air type nozzle in which the injection port for the oxidizing agent is disposed inside, the shape of the injection port is a single circular shape. Therefore, the cross-section area hardly changes even if the shape thereof changes due to thermal expansion and thermal shrinkage, thereby securing the spraying performance.

### Embodiment 2

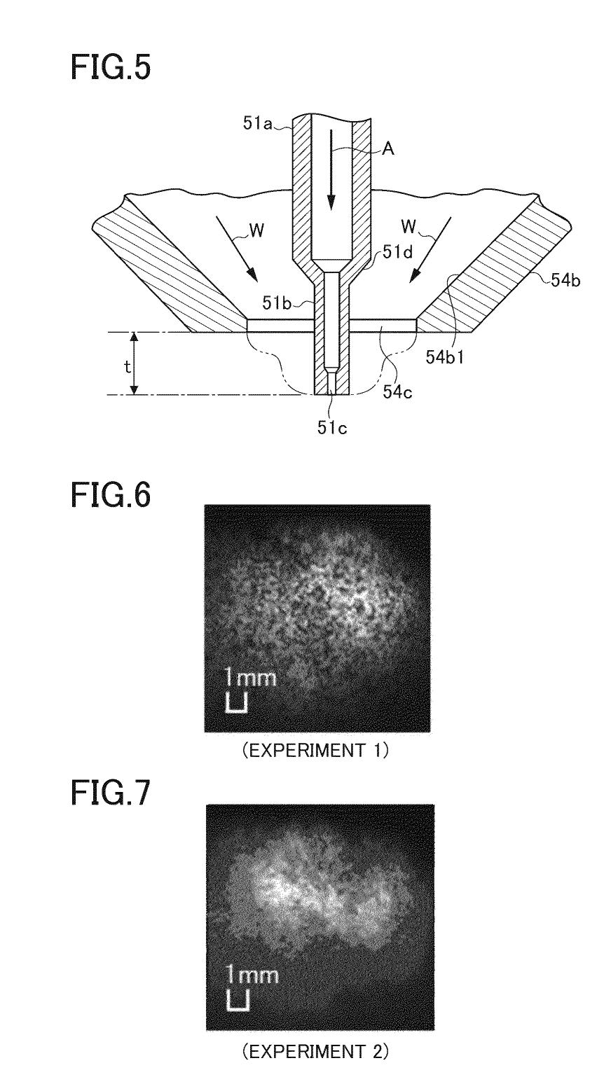

FIG. 5 shows a second embodiment of the apparatus. In FIG. 5, the same components as that of the first embodiment are indicated by the same reference signs and detailed explanation thereof are omitted. When the fluid to be treated W contains a large solid material, the outlet 54c of the nozzle 25 needs to be expanded to allow the solid material to pass through the outlet 54c. However, if the outlet 54c is expanded, the fluid flows away from the injection port 51c for the oxidizing agent. That is, it becomes difficult to make the injected oxidizing agent crash the fluid to be treated W. Without crashing the injected oxidizing agent with the fluid W, the fluid W will not be atomized.

In the second embodiment, in order to prevent the atomization effect from decreasing while having the above-mentioned structure to suppress the clogging of the solid materials, the head of the oxidizing agent injector 51 is protruded more than the head of the outlet 54c for the fluid to be treated W. With this, it produces an effect to gather the fluid discharged from the outlet 54c toward the injection port 51c. Specifically, after the fluid to be treated W is discharged from the outlet 54c, the fluid W is pulled toward the oxidizing agent injector 51 by the action of liquid surface tension and flows along the injector 51 to the injection port 51c.

The two-dot chain line in FIG. 5 schematically shows the state where the fluid to be treated W gathers to the oxidizing agent injector 51. By modifying the structure of the oxidizing agent injector 51 to be protruded more than the outlet 54c, it becomes possible to control the behavior of the fluid W discharged from the outlet 54c with the action of the liquid surface tension. That is, although the aperture width of the outlet 54c is expanded so as to prevent the clogging of the solid materials, the fluid W discharged from the outlet 54c flows along the oxidizing agent injector 51 because of the liquid surface tension. Accordingly, it becomes possible to prevent in sufficient atomization of the fluid W.

The inventors of this disclosure also carried out experiments to confirm the atomization performance of the nozzle 25 according to the second embodiment. Note that in the experiments, water is used instead of the fluid to be treated. FIGS. 6 and 7 are photo images of the experimental results achieved by the atomization.

The condition of the experiment of FIG. 6 is as follows: Pressure inside a container (reactor)=10 MPa; Pressure difference=0.2 MPa; Diameter of the injection port for the oxidizing agent=φ1.0 mm; Flow rate of the oxidizing agent=6.8 kg/h; Flow rate of the fluid to be treated=10 kg/h; Diameter of the outlet for the fluid to be treated=1 mm; Injection speed=53 m/s; Cross-section area ratio S1:S2=1:7; Flow rate ratio Q1/Q2=0.68.

The condition of the experiment of FIG. 7 is as follows: Pressure inside a container (reactor)=4 MPa; Pressure difference=0.3 MPa; Diameter of the injection port for the oxidizing agent=φ1.2 mm; Flow rate of the oxidizing agent=20 kg/h; Flow rate of the fluid to be treated=10 kg/h; Diameter of the outlet for the fluid to be treated=1 mm; Injection speed=110 m/s; Cross-section area ratio S1:S2=1:5; Flow rate ratio Q1/Q2=2.0.

The experiments of FIGS. 6 and 7 have different injection speeds, cross-section area ratios, and flow rate ratios. However, every value is within the preferable condition described above. From the results of the experiments, it was confirmed that the water was atomized such that the particle diameter became smaller than 250 μm. Note that it is known that the oxidation-decomposition process inside the reactor 4 is sufficiently achieved when the particle diameter is smaller than 250 μm.

In the above embodiments, the oxidizing agent (e.g., compressed high-pressure air) flows inside the oxidizing agent injector 51 and the fluid to be treated W flows through the space between the oxidizing agent injector 51 and the fluid discharger 50. Due to the friction with the fluid W, the oxidizing agent injector 51 and the fluid discharger 50 may be worn. Further, due to disposal of organic wastewater under the high-temperature and high-pressure water, due to disposal of wastewater containing organic matters, and/or detoxifying treatment of the fluid to be treated W; the oxidizing agent injector 51 and the fluid discharger 50 may be corroded.

Therefore, it is preferable to provide the oxidizing agent injector 51 and the fluid discharger 50 to be made of metal having friction resistance and corrosion resistance. For instance, the metal may contain gold (Au), platinum (Pt), or palladium (Pd). Alternatively the metal the oxidizing agent injector 51 and the fluid discharger 50 may be made of an alloy containing at least one of titanium (Ti), gold (Au), platinum (Pt), nickel (Ni), and palladium (Pd). Alternatively, it may be made of ceramic, preferably inconel (INC) 625 or titanium (Ti).

The fluid treatment apparatus of the above described embodiments carries out the treatment under the following condition. The temperature is set at 374.2° C. or more, and the pressure inside the reactor is set at 22.1 MPa or more. Here, the set temperature exceeds the critical temperature of water and the set pressure exceeds the critical pressure of water. Further, the set temperature also exceeds the critical temperature of air and the set pressure also exceeds the critical pressure of air. In the supercritical fluid, the organic matters are excellently dissolved and satisfactorily contact the air. Accordingly, the oxidation decomposition of the organic matters progresses dramatically. Alternatively, the temperature may be set at 200° C. or more (preferably, at 374.2° C. or more), and the pressure may be set at less than 22.1 MPa (preferably, at 10 MPa or more). Here, the set temperature is set at a temperature less than the saturated vapor temperature and the set pressure is set to be fairly high. In such a case, the fluid contained in the mixed fluid may be converted to overheating steam in the reactor 4.

The above mentioned embodiments exemplarily show the fluid containing the solid material. However, the embodiments described in this disclosure are also applicable to decomposition treatment for aqueous solution containing waste solvent such as alcohols and phenols.

Hereinafter, the effects of using the nozzle of this disclosure will be described with reference to results of the comparative experiments between the second embodiment and comparative examples. The comparative examples do not include the nozzle 25.

### First Experiment

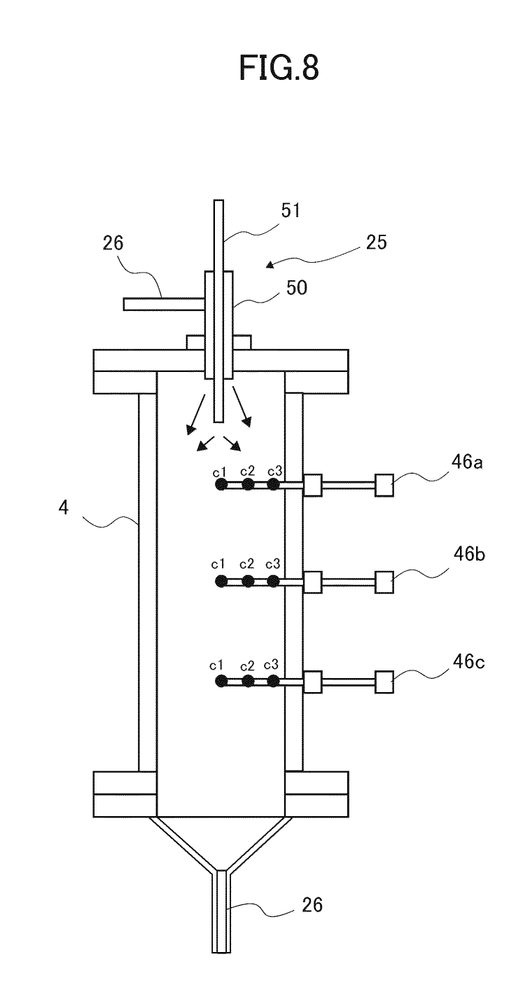

As illustrated in FIG. 8, the fluid treatment apparatus 1 of the second embodiment is equipped with multi-point temperature sensors 46a, 46b, and 46c inside the reactor 4. Here, a plurality (e.g., three) of multi-point temperature sensors 46a, 46b, and 46c are arranged at regular intervals in the vertical direction. With this, the first experiment was carried out to analyze the effects of the nozzle 25. As indicated by black dots, each temperature sensor 46 includes a plurality of detection points c1, c2, and c3 in the radial direction from the center of the reactor 4.

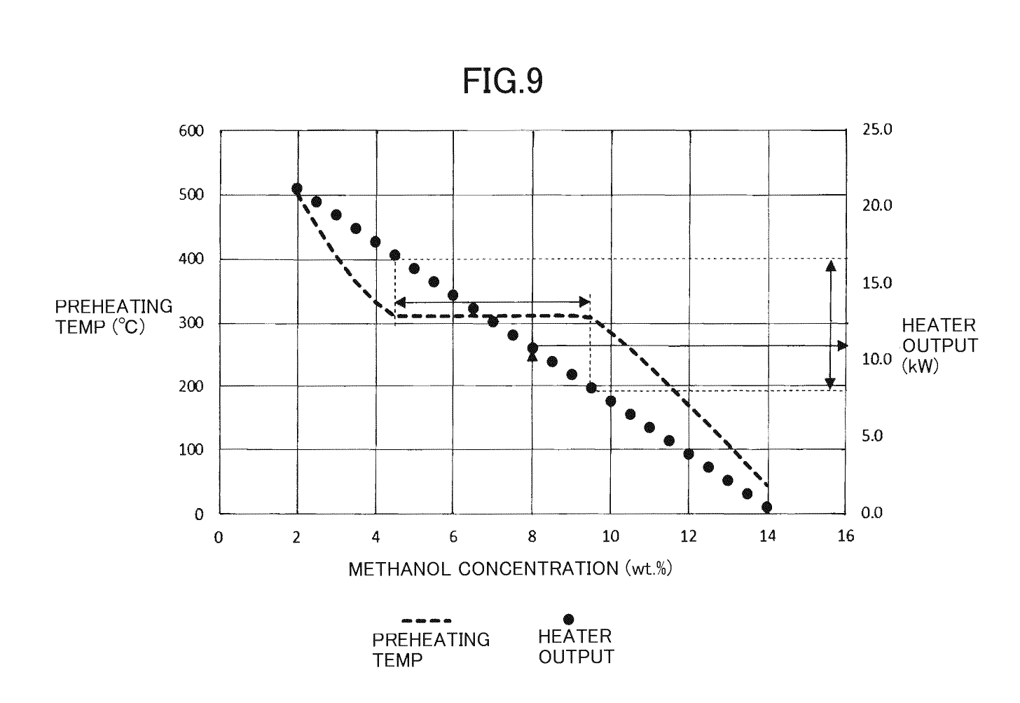

Here, if a concentration of methanol aqueous solution increases while maintaining reaction temperature inside the reactor at a predetermined temperature, output of a preheater decreases. FIG. 9 shows an example of output values (heater outputs) and preheating temperature of the first preheater 14 with respect to the concentrations of the methanol aqueous solution. As shown in FIG. 9, the preheating temperature becomes constant when the concentration of the methanol aqueous solution is in the range between 4.5 wt. % and 7.5 wt. %. That means, this range shows a transaction range from gas-phase to liquid-phase and is mixed with the gas-phase and liquid-phase.

The condition of the first experiment is shown below table.

| | EMBODIMENT 1 | EXPERIMENT 1 |
|---|---|---|
| INJECTION NOZZLE | ◯ | X |

| | |
|---|---|
| FLUID TO BE TREATED | Methanol Aqueous Solution |
| | (4 wt. % to 12 wt. %) |
| OXIDIZING AGENT | Air |
| PREHEATING TEMP | 400° C. for Air |
| | Wastewater is preheated to 340° C. and |
| | gradually decreased |
| PRESSURE | 10 MPa |
| REACTION TEMP | 480 ± 20° C. |
| RETENTION TIME | about 60 sec. |
| REACTOR STRUCTURE | Outer Cylinder: made of Inconel |
| | Inner Cylinder: made of Titanium |
| CATALYST MEMBER | Titanium with Pd plating having a |
| | cylindrical shape |

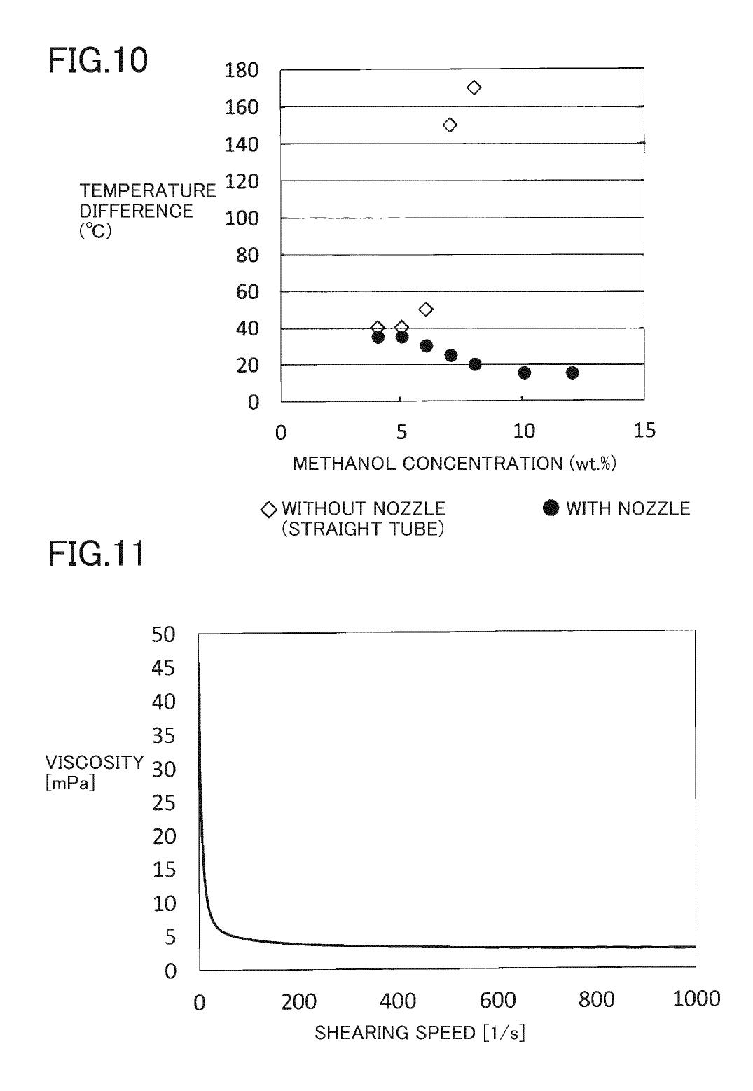

FIG. 10 shows the experimental result. The horizontal axis of the graph shows the methanol concentrations, and the vertical axis thereof shows the temperature differences inside the reactor 4. Each of the temperature differences shown in the graph represents a difference between the maximum value and the minimum value among all the detection points at each methanol concentration. Under the above-mentioned condition, if the apparatus does not include a nozzle, the temperature difference abruptly increases at the point where the methanol concentration is about 6 wt. %, as shown in FIG. 10. Without the nozzle, the point right under the injection port (i.e., at the detection point c1 of the temperature sensor 46a) shows the lowest temperature, while the point above the outer peripheral side of the reactor 4 (i.e., at the detection point c3 of the temperature sensor 46a) shows the highest temperature. It appears that the state of the aqueous solution (fluid) was shifted to a state including more liquid-phase as the output of the first preheater 14 decreased.

In contrary, if the apparatus includes a nozzle, the temperature difference is suppressed to be a few dozens of degrees even at the point where the methanol concentration is about 12 wt. %, as shown in FIG. 10. Hence, the temperature distribution is uniformed. Further, the Total Organic Carbon (TOC) with the nozzle becomes 28 mg/L. (The TOC without the nozzle is 500 mg/L or more). Therefore, by including the nozzle, the reaction efficiency of the apparatus is improved.

As described above, even if the fluid to be treated is introduced into the reactor 4 in the liquid-phase, the nozzle properly atomizes the fluid and uniforms the temperature inside the reactor 4. As a result, it brings excellent effects. For instance, it becomes possible to prevent the temperature from being high locally, and therefore, it creates a design margin in the heat resistant design.

### Second Experiment

Table 1 shows atomization result at each viscosity obtained with the nozzle configuration shown in FIG. 5. The condition of the Table 1 is as follows: Pressure inside the container (reactor)=10 MPa; Pressure difference=0.2 MPa; Diameter of the injection port for the oxidizing agent=φ1.0 mm; Flow rate of the oxidizing agent=6.8 kg/h; Flow rate of the fluid to be treated=10 kg/h; Viscosities of the fluid=as shown in Table 1; Component of the fluid: polyvinyl alcohol (PVA); Diameter of the outlet for the fluid to be treated=1 mm; Injection speed=53 m/s; Cross-section area ratio S1:S2=1:7; Flow rate ratio Q1/Q2=0.68.

Table 1 shows the atomization results of the second experiment.

TABLE 1
(ATOMIZATION RESULT AT EACH VISCOSITY)

| | VISCOSITY | | |
|---|---|---|---|
| | 1 mPa · s | 3 mPa · s | 10 mPa · s |
| MAX. PARTICLE DIAMETER | ≦100 μm | ≦300 μm | ≦500 μm |

As shown in Table 1, the particle diameter increases as the viscosity of the fluid increases. Here, the particle diameter of the fluid is atomized up to 500 μm even when the viscosity of the fluid is 10 mPa·s. The results shown in Table 1 also indicate that the particle diameter is decreased by increasing the injection speed. Consequently, the apparatus 1 is capable of spraying high viscosity fluid with the nozzle according to the embodiment.

### Third Experiment

As a third experiment, an atomization experiment was carried out using wastewater as the fluid to be treated by using the nozzle configuration illustrated in FIG. 5.

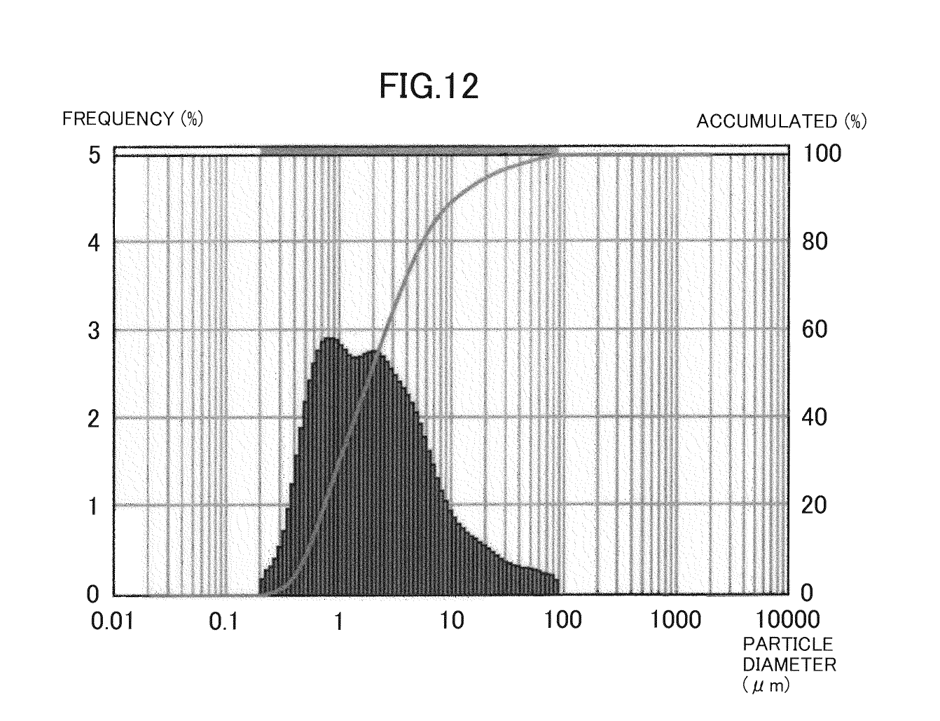

The condition of the third experiment is as follows: Pressure inside the container (reactor)=10 MPa; Pressure difference=0.2 MPa; Diameter of the injection port for the oxidizing agent=φ1.0 mm; Flow rate of the oxidizing agent=6.8 kg/h; Flow rate of the fluid to be treated=10 kg/h; Viscosities of the fluid=as shown in FIG. 11; Component of the fluid: wastewater containing a solid material as shown in FIG. 12; Diameter of the outlet for the fluid to be treated=1 mm; Injection speed=53 m/s; Cross-section area ratio S1:S2=1:7; Flow rate ratio Q1/Q2=0.68.

Through the third experiment, the viscos fluid containing a solid material was atomized such that the particle diameter thereof becomes less than 250 μm. Besides, in the third Experiment, the spraying was continued for about five hours, and result showed that neither pressure variation at the inlet of the reactor nor clogging of the wastewater occurred. Consequently, the second embodiment of this disclosure prevents an occurrence of clogging even if the fluid to be treated contains solid materials such as an organic matter and an inorganic matter. Further, it provides a fluid treatment apparatus that improves the reaction efficiency of the fluid through the atomization.

### Fourth Embodiment

In the fourth experiment, high pressure water pressurized at 0.7 MPa is used as the heat exchange fluid TF stored in the heat catalyst tank 30 of the heat exchange section 5, and an experiment of steam productivity was carried out. The condition of the fourth experiment is similar to that of the first experiment with methanol concentration at 12 wt. % but the flow rate of the fluid to be treated is set to 6 kg/h.

Table 2 shows the atomization results of the fourth experiment.

TABLE 2
(STEAM PRODUCTIVITY OF TREATMENT-FINISHED
FLUID UNDER EACH CONDITION)

| | | | TREATMENT- | TREATMENT- |
|---|---|---|---|---|
| | | OUT- | FINISHED | FINISHED |
| | INLET | LET | FLUID TEMP | FLUID TEMP |
| | STEAM | STEAM | BEFORE | AFTER |
| | FLOW | FLOW | STEAM | STEAM |
| | RATE | RATE | PRODUCTION | PRODUCTION |
| CONDITION | [L/h] | [° C.] | [° C.] | [° C.] |
| 1 | 80 | 85 | 350 | 35 |
| 2 | 60 | 105 | 350 | 35 |
| 3 | 40 | 145 | 350 | 40 |
| 4 | 20 | 170 | 350 | 60 |

As shown in Table 2, temperature of the treatment-finished fluid right before heat exchanging, i.e., of the treatment-finished fluid entering the heat exchanger 29, is increased to 350° C. by the combustion of the methanol. In the fourth experiment, a flow rate at a steam inlet (i.e., a flow rate of the heat exchange fluid TF entering the heat exchanger 29) was gradually decreasing from 80 L/h to 20 L/h. When the flow rate was at 80 L/h, the temperature of the produced steam was increased to only 85° C. However, when the flow rate was at 20 L/h, a high pressure steam was produced and the temperature thereof reached 170° C. Further, the treatment-finished fluid was cooled down to 60° C. or less. As described above, the nozzle according to the embodiments of this disclosure is even applicable to an apparatus for combustion producing steam.

Although the disclosure has been described in terms of exemplary embodiments, it is not limited thereto. It should be appreciated that variations or modifications may be made in the embodiments described by persons skilled in the art without departing from the scope of the present invention as defined by the following claims.

What is claimed is:

1. A fluid treatment apparatus, comprising:
a reactor that decomposes an organic matter contained in a mixed fluid of a fluid to be treated and an oxidizing agent so as to treat the fluid;
an oxidizing agent injector that includes an injection port to inject the oxidizing agent into the reactor;
a fluid discharger that is disposed to surround the oxidizing agent injector and includes an outlet to discharge the fluid in the reactor; and
a pressurizer that pressurizes the oxidizing agent, wherein
the fluid discharger has a fluid passage a diameter of which is larger than a maximum particle diameter of a solid material contained in the fluid and a shape of which does not create a pressure difference in the fluid passage, the outlet of the fluid discharger being provided to discharge the fluid toward the oxidizing agent injector, and
the apparatus atomizes the fluid by pressure energy of the injected oxidizing agent.

2. The apparatus according to claim 1, wherein a head of the oxidizing agent injector is protruded more than the fluid discharger.

3. The apparatus according to claim 1, wherein supply pressure of the oxidizing agent is equal to or greater than atmospheric pressure.

4. The apparatus according to claim 1, wherein a pressure difference between supply pressure of the oxidizing agent and pressure inside the reactor is less than 2 MPa.

5. The apparatus according to claim 4, wherein injection speed of the oxidizing agent is less than 200 m/s.

6. The apparatus according to claim 1, wherein when S1 denotes a cross-section area of the injection port of the oxidizing agent injector and S2 denotes a cross-section area of the outlet of the fluid discharger, a ratio S1:S2 is set to be in a range between 1:1 and 1:40.

7. The apparatus according to claim 1, wherein when Q1 denotes a flow rate of the oxidizing agent injected from the oxidizing agent injector and Q2 denotes a flow rate of the fluid discharged from the fluid discharger, a flow rate ratio Q1/Q2 is set to be 0.3 or more to less than 6.

8. A fluid treatment apparatus, comprising:
a reactor that decomposes an organic matter contained in a mixed fluid of a fluid to be treated and an oxidizing agent so as to treat the fluid;
an oxidizing agent injector that includes an injection port to inject the oxidizing agent into the reactor;
a fluid discharger that is disposed to surround the oxidizing agent injector and includes an outlet to discharge the fluid in the reactor; and
a pressurizer that pressurizes the oxidizing agent, wherein
the fluid discharger has a fluid passage a diameter of which is larger than a maximum particle diameter of a solid material contained in the fluid and a shape of which does not create a pressure difference in the fluid passage, the outlet of the fluid discharger being provided to discharge the fluid toward the oxidizing agent injector,
supply pressure of the oxidizing agent is equal to or higher than atmospheric pressure,
a pressure difference between supply pressure of the oxidizing agent and pressure inside the reactor is less than 2 MPa, and
injection speed of the oxidizing agent is less than 200 m/s.

9. A fluid treatment apparatus, comprising:
a reactor that decomposes an organic matter contained in a mixed fluid of a fluid to be treated and an oxidizing agent so as to treat the fluid;
an oxidizing agent injector that includes an injection port to inject the oxidizing agent into the reactor;
a fluid discharger that is disposed to surround the oxidizing agent injector and includes an outlet to discharge the fluid in the reactor; and
a pressurizer that pressurizes the oxidizing agent, wherein
the fluid discharger has a fluid passage a diameter of which is larger than a maximum particle diameter of a solid material contained in the fluid and a shape of which does not create a pressure difference in the fluid passage, the outlet of the fluid discharger being provided to discharge the fluid toward the oxidizing agent injector,
supply pressure of the oxidizing agent is set higher than pressure inside the reactor,
the supply pressure is determined such that a pressure difference between the supply pressure and the pressure inside the reactor is smaller than a predetermined value and that injection speed of the oxidizing agent at the injection port is smaller than a threshold value, and
the apparatus atomizes the fluid by injecting the oxidizing agent to the discharged fluid.

10. The apparatus according to claim 1, further comprising a heat exchange section that takes out heat by using a heat exchange medium from the reactor or treatment-finished fluid drained from the reactor and utilizes the taken heat as thermal energy.
